(19) United States
(12) Patent Application Publication
(10) Pub. No.: US 2013/0145175 A1
(43) Pub. Date: Jun. 6, 2013

(54) METHOD AND APPARATUS FOR ENCIPHERING/DECIPHERING DIGITAL RIGHTS MANAGEMENT OBJECT

(71) Applicants: Pang-Chieh Wang, Kaohsiung City (TW); Jun-Bin Shi, Dounan Town (TW); Shu-Fen Yang, Guanxi Township (TW)

(72) Inventors: Pang-Chieh Wang, Kaohsiung City (TW); Jun-Bin Shi, Dounan Town (TW); Shu-Fen Yang, Guanxi Township (TW)

(73) Assignee: INDUSTRIAL TECHNOLOGY RESEARCH INSTITUTE, HSINCHU (TW)

(21) Appl. No.: 13/438,943

(22) Filed: Apr. 4, 2012

(30) Foreign Application Priority Data
Dec. 6, 2011 (TW) 100144911

(51) Int. Cl. G06F 21/00

(52) U.S. Cl. 713/189

(57) ABSTRACT

A method and an apparatus for enciphering/deciphering digital rights management object are provided. The DRM enciphering method includes the following steps: A plurality of content objects which are divided from a digital content are received. A plurality of DRM vectors are generated according to tacit information between the DRM enciphering apparatus and the DRM deciphering apparatus. The content objects are respectively enciphered according to the DRM vectors to generate a plurality of DRM objects.

This application claims the benefit of Taiwan application Serial No. 100144911, filed Dec. 6, 2011, the disclosure of which is incorporated by reference herein in its entirety.

### BACKGROUND

1. Technical Field

The disclosed embodiments relate in general to a method and an apparatus for enciphering/deciphering digital rights management object.

2. Description of the Related Art

Along with the popularization and diversification of the service of the digital content, the digital rights management is being generally applied to each electronic product or Internet service. The purposes of the digital rights management are for protecting the spread of the digital content from infringement such as unauthorized copy or use of the digital content and for defining the commercial operation mode according to the form of the digital content and the function of the related electronic products. Currently, most of the digital rights systems are combined with the online paying system to form a complete digital online service.

The Open Mobile Alliance (OMA) integrates plenty of service standard organizations (such as WAP forum, Wireless Village, SyncML, LiF, and so on) of the field, and aims to develop joint open standards for being conformed to the market demand and for helping to establish the compatible and interactive services working across nations, operators, and mobile terminals. Currently, the OMA has already been developed into a global standard organization having more than 350 members. The OMA has established 15 work teams, such as Requirements, Architecture, Security, Interoperability, Browser & Content, Location, and Push to talk over cellular, for developing different standards for the application layer with respect to different value-added services.

Different DRM systems are working online, and meantime the OMA defines a standard of DRM. The latest version is OMA DRM 2.1. Each of the standards of OMA and the different DRM systems defines the related rights of the digital content purchased by a user, and encrypts the delivered digital content. Only the authorized users and apparatuses are allowed to use the delivered digital content.

However, a user could have many apparatuses, for example, the home computer, the notebook computer, the handheld device, used in different conditions. Therefore, each DRM system defines a domain or a mechanism similar to a domain. A user may define his/her own devices as being in the same domain, such that the user is allowed to download or copy or use the content in many devices after buying the digital content one time. Certainly, an apparatus can only belong to one domain, and the quantity of the apparatuses in the one domain is limitary. The corresponding relationship of the domain makes the spread of the digital content much easier. Unlike the purchase of general software which provides authorization with respect to a machine (apparatus), the purchase of the digital content provides authorization with respect to a user and his/her machine (apparatus) of the domain because the purchase of the digital content is for the use (or browsing) of the user.

### SUMMARY

The disclosure is directed to a method and an apparatus for enciphering/deciphering digital rights management object.

According to one embodiment, a DRM enciphering method is provided. The DRM enciphering method is applicable to DRM enciphering apparatus and may be implemented by a processor. The DRM enciphering method includes the following steps. A plurality of content objects which are divided from a digital content are received. A plurality of DRM vectors are generated according to tacit information between the DRM enciphering apparatus and the DRM deciphering apparatus. The content objects are respectively enciphered according to the DRM vectors to generate a plurality of DRM objects.

According to another embodiment, a DRM object deciphering method is provided. The DRM object deciphering method is applicable to a DRM deciphering apparatus having a transaction number of a digital content and may be implemented by a processor. The DRM object deciphering method includes the following steps. A plurality of DRM vectors are generated according to tacit information between the DRM enciphering apparatus and the DRM deciphering apparatus. A plurality of DRM objects are respectively deciphered according to the DRM vectors to generate the content objects.

According to an alternative embodiment, a DRM enciphering apparatus is provided. The DRM enciphering apparatus includes a receiving unit, a DRM vector generation unit and a DRM object generation unit. The receiving unit receives a plurality of content objects which are divided from a digital content. The DRM vector generation unit generates a plurality of DRM vectors according to tacit information between the DRM enciphering apparatus and the DRM deciphering apparatus. The DRM object generation unit respectively enciphers the content objects according to the DRM vectors to generate a plurality of DRM objects.

According to an alternative embodiment, a DRM deciphering apparatus is provided. The DRM deciphering apparatus having a transaction number of a digital content includes a DRM vector generation unit and a content object generation unit. The DRM vector generation unit generates a plurality of DRM vectors according to tacit information between the DRM enciphering apparatus and the DRM deciphering apparatus. The content object generation unit respectively deciphers the DRM objects according to the DRM vectors to generate the content objects.

### BRIEF DESCRIPTION OF THE DRAWINGS

FIG. 1 is a schematic diagram showing a DRM enciphering apparatus and a DRM deciphering apparatus;

FIG. 2 is a flowchart of a DRM enciphering method;

FIG. 3 is a flowchart of a DRM object deciphering method;

FIG. 4 is a schematic diagram showing the generation of a DRM vector;

FIG. 5 is a first schematic diagram showing a DRM object generation unit;

FIG. 6 is a first detailed flowchart of step 23;

FIG. 7 is a first schematic diagram showing a content object generation unit;

FIG. 8 is a first detailed flowchart of step 32;

FIG. 9 is a second schematic diagram showing a DRM object generation unit;

FIG. 10 is a second detailed flowchart of step 23;

FIG. 11 is a second schematic diagram showing a content object generation unit; and

FIG. 12 is a second detailed flowchart of step 32.

In the following detailed description, for purposes of explanation, numerous specific details are set forth in order to provide a thorough understanding of the disclosed embodiments. It will be apparent, however, that one or more embodiments may be practiced without these specific details. In other instances, well-known structures and devices are schematically shown in order to simplify the drawing.

### DETAILED DESCRIPTION

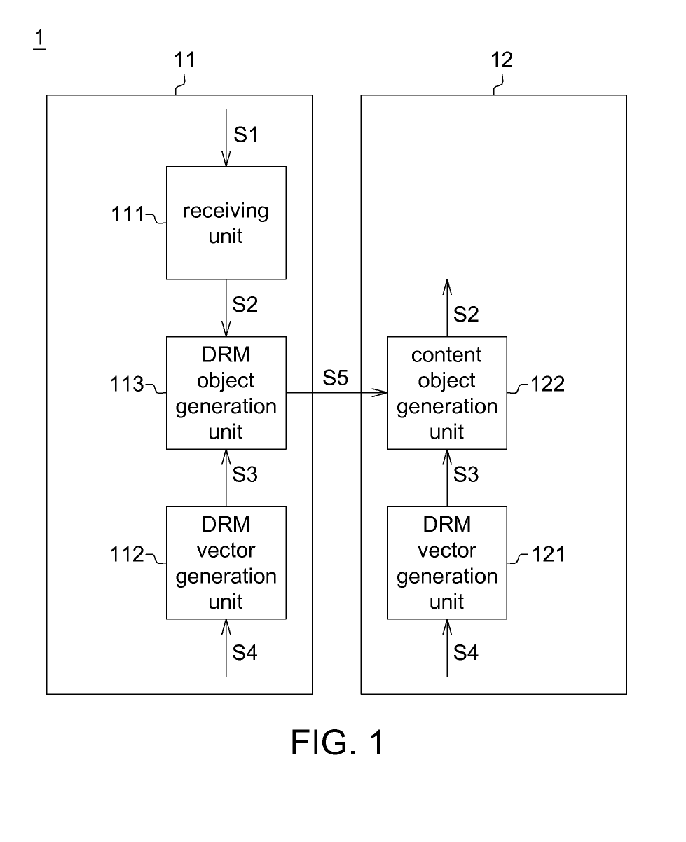

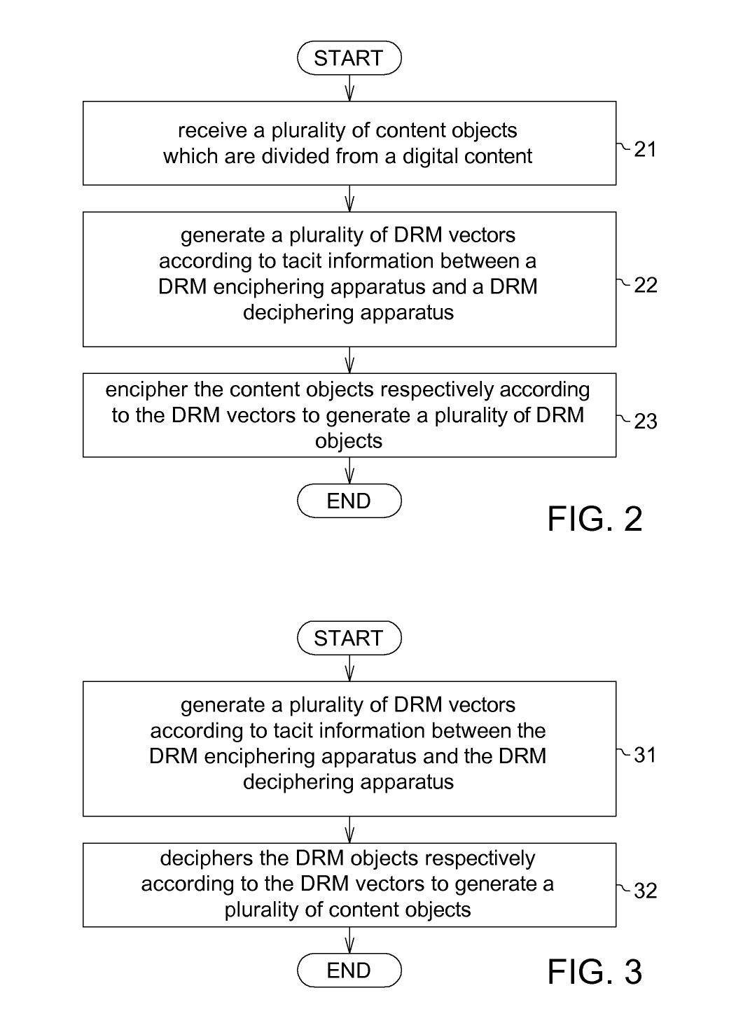

Referring to FIG. 1, FIG. 2 and FIG. 3. FIG. 1 is a schematic diagram showing a DRM enciphering apparatus and a DRM deciphering apparatus. FIG. 2 is a flowchart of a DRM enciphering method. FIG. 3 is a flowchart of a DRM object deciphering method. The DRM enciphering apparatus 11 includes a receiving unit 111, a DRM vector generation unit 112 and a DRM object generation unit 113. The DRM deciphering apparatus 12 having a transaction number of a digital content includes a DRM vector generation unit 121 and a content object generation unit 122. The DRM enciphering apparatus 11 may be realized by a server, a client or a processor. The DRM deciphering apparatus 12 may be realized by a server, a client or a processor. When the DRM enciphering apparatus 11 is a server, the DRM deciphering apparatus 12 is a client. Conversely, when the DRM enciphering apparatus 11 is a client, the DRM deciphering apparatus 12 is a server. The client is such as a home computer, a tablet PC, a notebook computer, or a handheld device. The DRM enciphering method is applicable to the DRM enciphering apparatus 11, and includes the following steps:

As shown in step 21, the receiving unit 111 receives a plurality of content objects S2 which are divided from a digital content S1. The digital content is such as a book, a magazine, a cartoon, a song or a film. The receiving unit 111 receives a plurality of content objects S2 which are divided from the digital content S1 according to the context or paragraphs recognizable to the user. Alternatively, the receiving unit 111 receives a plurality of content objects S2 which are divided from the digital content S1 according to file size (or stationery points of voice).

As shown in step 22, the DRM vector generation unit 112 generates a plurality of DRM vectors S3 according to tacit information S4 between the DRM enciphering apparatus 11 and the DRM deciphering apparatus 12. The DRM vectors S3 have a fixed length, and are different values from each other. As shown in step 23, the DRM object generation unit 113 enciphers the content objects S2 respectively according to the DRM vectors S3 to generate a plurality of DRM objects S5.

The DRM object deciphering method is applicable to DRM deciphering apparatus 12, and comprising the followings. As shown in step 31, the DRM vector generation unit 121 generates a plurality of DRM vectors S3 according to tacit information S4 between the DRM enciphering apparatus 11 and the DRM deciphering apparatus 12. As shown in step 32, the content object generation unit 122 deciphers the DRM objects S5 respectively according to the DRM vectors S3 to generate a plurality of content objects S2.

It is noted that the tacit information S4 is already obtained by the DRM enciphering apparatus 11 and the DRM deciphering apparatus 12 before the delivery of the DRM object S5. Theoretically, the tacit information does not need to be transmitted during the delivery of the DRM object S5. The tacit information may further include a plurality of tacit values from which the DRM vectors S3 are obtained through a logical operation. The logical operation may have plenty of implementations. For example, the logical operation is an exclusive-or (XOR) operation or a hash function operation. The tacit information, not transmitted during the delivery of the DRM object S5, is further protected from being deciphered by illegal users.

The aforementioned tacit values include, for example, the information related to the content object S2, the ID of the DRM deciphering apparatus 12, the transaction number of the digital content S1, the request time of the DRM deciphering apparatus 12, the previous last requested object ID of the DRM deciphering apparatus 12 or the user information of the DRM deciphering apparatus 12 or any combination of above.

The information related to the content object S2 is such as a serial number of the content object. The ID of the DRM deciphering apparatus 12 is such as a machine number of the DRM deciphering apparatus 12. The transaction number of the digital content S1 is such as transaction information when the user purchases the digital content. The request time of the DRM deciphering apparatus 12 is such as the previous time when the DRM deciphering apparatus 12 requests a DRM object of the RM enciphering apparatus 11. The previous last requested object ID of the DRM deciphering apparatus 12 is such as the serial number of the DRM object requested of the DRM enciphering apparatus 11 by the DRM deciphering apparatus 12. If the

DRM deciphering apparatus 12 has never requested any DRM objects of the DRM enciphering apparatus 11, the default value of the previous last requested object ID is set as 0. The user information is such as an account number or a password.

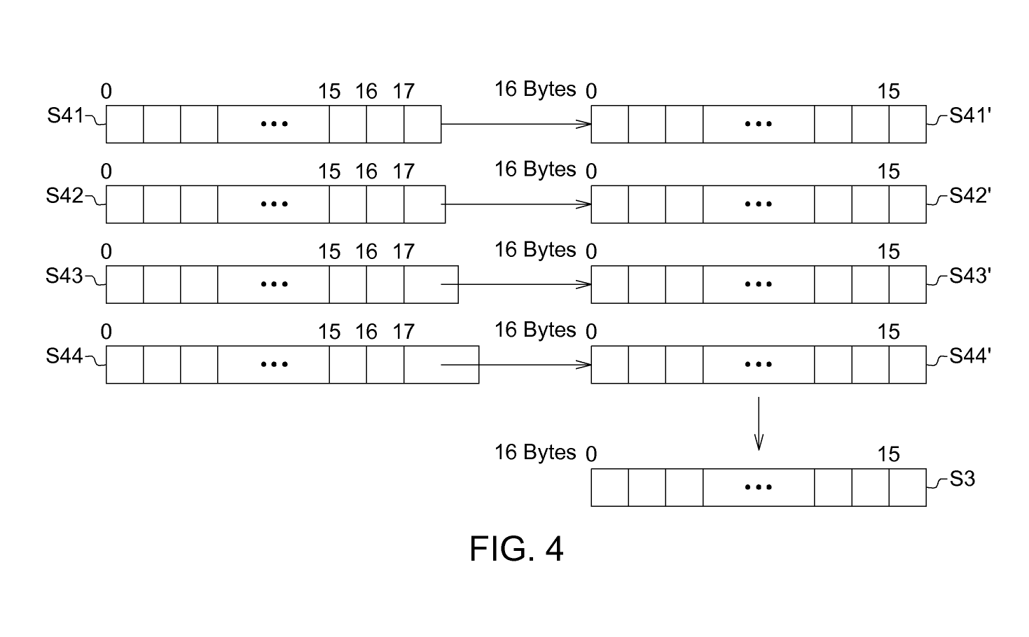

Referring to FIG. 4, a schematic diagram showing the generation of a DRM vector is shown. For example, the aforementioned tacit value includes the previous last requested object ID S41 of the DRM deciphering apparatus 12, the user information S42 of the DRM deciphering apparatus 12, the ID S43 of the DRM deciphering apparatus 12 and the request time S44 of the DRM deciphering apparatus 12. The DRM vector generation unit performs a hash function operation on the previous last requested object ID S41, the user information S42, the ID S43 and request time S44 respectively to generate a previous last requested object ID S41′, a user information S42′, an ID S43′ and a request time S44′ respectively. Then, the DRM vector generation unit performs an exclusive-or (XOR) operation on the previous last requested object ID S41′, the user information S42′, the ID S43′ and the request time S44′ to generate a plurality of DRM vectors S3.

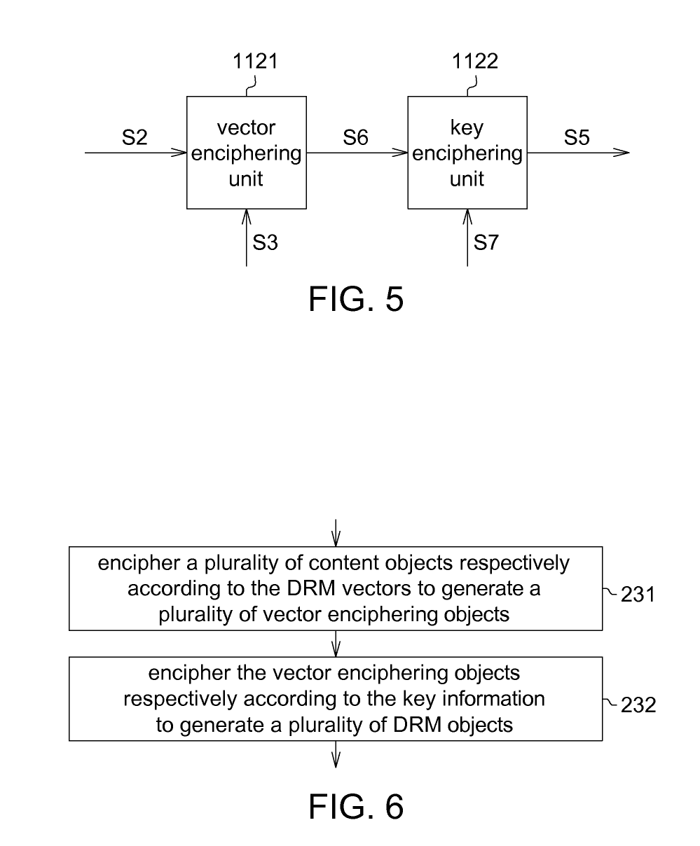

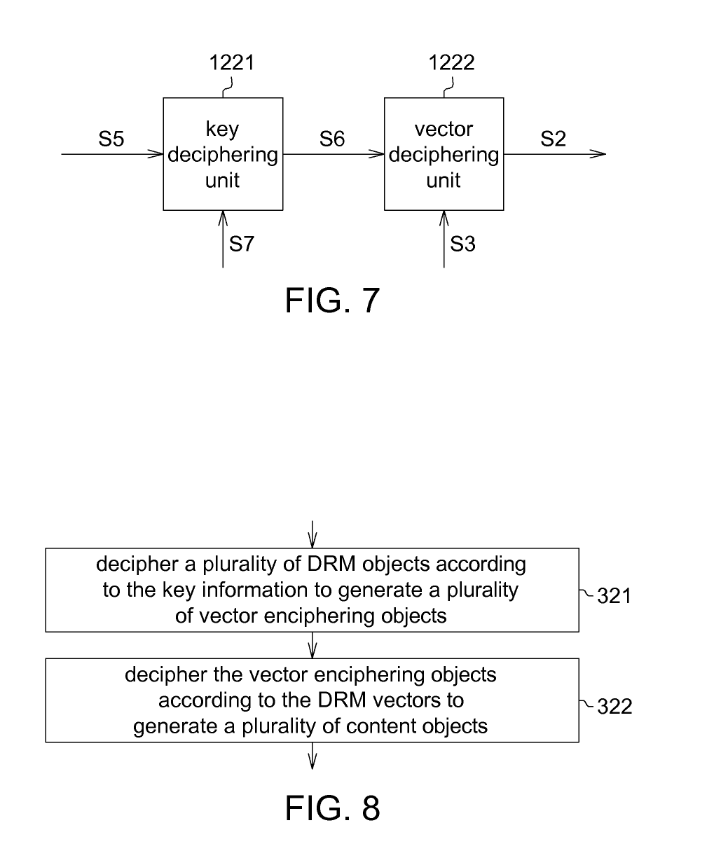

Referring to FIG. 5, FIG. 6, FIG. 7 and FIG. 8. FIG. 5 is a first schematic diagram showing a DRM object generation unit. FIG. 6 is a first detailed flowchart of step 23. FIG. 7 is a first schematic diagram showing a content object generation unit. FIG. 8 is a first detailed flowchart of step 32. In one embodiment, the aforementioned DRM object generation unit comprises, for example, a vector enciphering unit 1121 and a key enciphering unit 1122. In one embodiment, the aforementioned step 23, for example, further includes steps 231˜232. As shown in step 231, the vector enciphering unit 1121 enciphers the content objects S2 respectively according to the DRM vectors S3 to generate a plurality of vector enciphering objects S6. As shown in step 232, the key enciphering unit 1122 enciphers the vector enciphering objects S6 according to the key information S7 to generate a plurality of DRM objects S5.

In one embodiment, the aforementioned content object generation unit comprises, for example, a key deciphering unit 1221 and a vector deciphering unit 1222. In one embodiment, the aforementioned step 32, for example, further includes steps 321˜322. As shown in step 321, the key deciphering unit 1221 deciphers the DRM objects S5 according to the key information S7 to generate a plurality of vector enciphering objects S6. As shown in step 322, the vector deciphering unit 1222 deciphers the vector enciphering objects according to the DRM vectors S7 to generate a plurality of content objects S2.

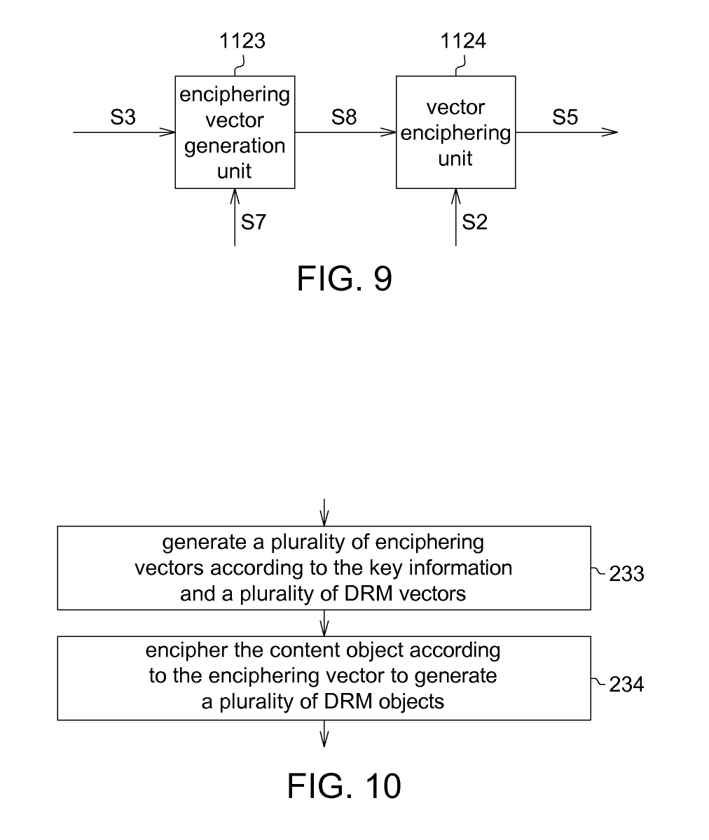

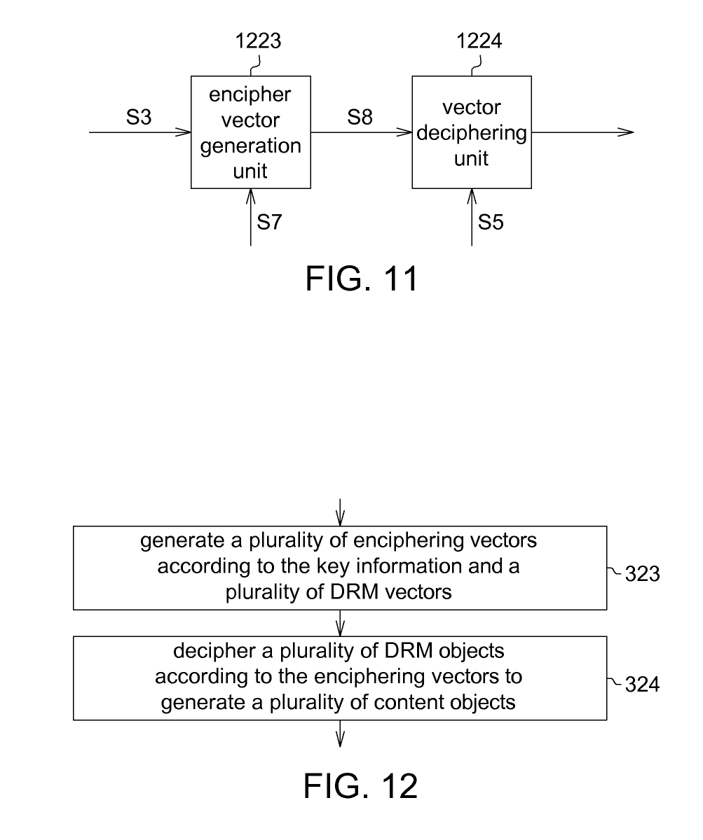

Referring to FIG. 9, FIG. 10, FIG. 11 and FIG. 12. FIG. 9 is a second schematic diagram showing a DRM object generation unit. FIG. 10 is a second detailed flowchart of step 23. FIG. 11 is a second schematic diagram showing a content object generation unit. FIG. 12 is a second detailed flowchart of step 32. In one alternate embodiment, the aforementioned DRM object generation unit includes, for example, an enciphering vector generation unit 1123 and a vector enciphering unit 1124. In one alternate embodiment, the aforementioned step 23, for example, further includes steps 233˜234. As shown in step 233, the enciphering vector generation unit 1123 generates a plurality of enciphering vectors S8 according to the key information S7 and the DRM vectors S3. As shown in step 234, the vector enciphering unit 1124 enciphers the content object S2 according to the enciphering vectors S8 to generate a plurality of DRM objects S5.

In one alternate embodiment, the aforementioned content object generation unit includes, for example, an enciphering vector generation unit 1223 and a vector deciphering unit 1224. In one alternate embodiment, the aforementioned step 32, for example, further includes steps 323˜324. As shown in step 323, the enciphering vector generation unit 1223 generates a plurality of enciphering vectors S8 according to the key information S7 and the DRM vectors S3. As shown in step 324, the vector deciphering unit 1224 deciphers the DRM objects S5 according to the enciphering vectors S8 to generate a plurality of content objects S2.

The method and apparatus for enciphering/deciphering DRM object are capable of dividing a digital content into different content objects according to actual context, pattern or browsing mode of the digital content, and further enciphering the content object according to the DRM vectors. When the user only purchases the digital rights for one copy of digital content, theoretically, the user only owns one use right instead of many use rights with respect to the digital content. Therefore, when there are many users, the corresponding use rights should be many as well. That is, at any time, different users are not allowed to own the same use right. To resolve such problem, the method and the apparatus for enciphering/deciphering DRM object of the disclosure not only control the correlation of the content objects browsed by the user with an apparatus but also prohibit the transferability of the same digital content between different apparatuses. Within a short period of time, the DRM apparatus system allows the same DRM object to be browsed by only one apparatus.

It will be apparent to those skilled in the art that various modifications and variations can be made to the disclosed embodiments. It is intended that the specification and examples be considered as exemplary only, with a true scope of the disclosure being indicated by the following claims and their equivalents.

What is claimed is:

1. A digital rights management (DRM) enciphering method applicable to a DRM enciphering apparatus and implemented by a processor, comprising:
Receiving a plurality of content objects which are divided from a digital content;
generating a plurality of DRM vectors according to a tacit information between a DRM enciphering apparatus and a DRM deciphering apparatus; and
enciphering the plurality of content objects respectively according to the plurality of DRM vectors to generate a plurality of DRM objects.

2. The DRM enciphering method according to claim 1, wherein the enciphering step comprises:
enciphering the plurality of content objects respectively according to the plurality of DRM vectors to generate a plurality of vector enciphering objects; and
enciphering the plurality of vector enciphering objects according to a key information to generate the plurality of DRM objects.

3. The DRM enciphering method according to claim 1, wherein the enciphering step comprises:
generating a plurality of enciphering vectors according to a key information and the plurality of DRM vectors; and
enciphering the plurality of content objects according to the plurality of enciphering vectors to generate the plurality of DRM objects.

4. The DRM enciphering method according to claim 1, wherein the tacit information comprises a plurality of tacit values from which the plurality of DRM vectors are obtained through a logical operation.

5. The DRM enciphering method according to claim 4, wherein the logical operation is an exclusive-or (XOR) operation or a hash function operation.

6. The DRM enciphering method according to claim 4, wherein the plurality of tacit values comprises the information associated with the plurality of content objects, the ID of the DRM deciphering apparatus, the transaction number of the digital content, the request time of the DRM deciphering apparatus, the previous last requested object ID of the DRM deciphering apparatus, or the user information of the DRM deciphering apparatus, or any combination of above.

7. The DRM enciphering method according to claim 1, wherein the plurality of DRM vectors have a fixed length.

8. The DRM enciphering method according to claim 1, wherein the plurality of DRM vectors are different values from each other.

9. A DRM object deciphering method, applicable to a DRM deciphering apparatus having a transaction number of a digital content, and implemented by a processor, comprising:
generating a plurality of DRM vectors according to a tacit information between a DRM enciphering apparatus and a DRM deciphering apparatus; and
deciphering the plurality of DRM objects respectively according to the plurality of DRM vectors to generate a plurality of content objects.

10. The DRM object deciphering method according to claim 9, wherein the deciphering step comprises:
deciphering the plurality of DRM objects according to a key information to generate a plurality of vector enciphering objects; and
deciphering the plurality of vector enciphering objects according to the plurality of DRM vectors to generate the plurality of content objects.

11. The DRM object deciphering method according to claim 9, wherein the content objects generation step comprises:
generating a plurality of enciphering vectors according to a key information and the plurality of DRM vectors; and
deciphering the plurality of DRM objects according to the plurality of enciphering vectors to generate a plurality of content objects.

12. The DRM object deciphering method according to claim 9, wherein the tacit information comprises a plurality of tacit values from which the plurality of DRM vectors are obtained through a logical operation.

13. The DRM object deciphering method according to claim 12, wherein the logical operation is an exclusive-or (XOR) operation or a hash function operation.

14. The DRM object deciphering method according to claim 12, wherein the plurality of tacit values comprises the information associated with the plurality of content objects, the ID of the DRM deciphering apparatus, the transaction number of the digital content, the request time of the DRM deciphering apparatus, the previous last requested object ID of the DRM deciphering apparatus, or the user information of the DRM deciphering apparatus, or any combination of above.

15. The DRM object deciphering method according to claim 9, wherein the plurality of DRM vectors have a fixed length.

16. The DRM object deciphering method according to claim 9, wherein the plurality of DRM vectors are different values from each other.

17. A DRM enciphering apparatus, comprising:
a receiving unit for receiving a plurality of content objects which are divided from a digital content;
a DRM vector generation unit for generating a plurality of DRM vectors according to a tacit information between the DRM enciphering apparatus and a DRM deciphering apparatus; and
a DRM object generation unit for enciphering the plurality of content objects respectively according to the plurality of DRM vectors to generate a plurality of DRM objects.

18. The DRM enciphering apparatus according to claim 17, wherein the DRM object generation unit comprises:
a vector enciphering unit for enciphering the plurality of content objects respectively according to the plurality of DRM vectors to generate a plurality of vector enciphering objects; and
a key enciphering unit for enciphering the plurality of vector enciphering objects according to a key information to generate the plurality of DRM objects.

19. The DRM enciphering apparatus according to claim 17, wherein the DRM object generation unit comprises:
an enciphering vector generation unit for generating a plurality of enciphering vectors according to a key information and the plurality of DRM vectors; and
a vector enciphering unit for enciphering the plurality of content objects according to the enciphering vectors to generate the plurality of DRM objects.

20. The DRM enciphering apparatus according to claim 17, wherein the tacit information comprises a plurality of tacit values from which the plurality of DRM vectors are obtained through a logical operation.

21. The DRM enciphering apparatus according to claim 20, wherein the logical operation is an exclusive-or (XOR) operation or a hash function operation.

22. The DRM enciphering apparatus according to claim 20, wherein the tacit values comprises the information associated with the plurality of content objects, the ID of the DRM deciphering apparatus, the transaction number of the digital content, the request time of the DRM deciphering apparatus, the previous last requested object ID of the DRM deciphering apparatus, or the user information of the DRM deciphering apparatus, or any combination of above.

23. The DRM enciphering apparatus according to claim 17, wherein the plurality of DRM vectors have a fixed length.

24. The DRM enciphering apparatus according to claim 17, wherein the plurality of DRM vectors are different values from each other.

25. A DRM deciphering apparatus having a transaction number of a digital content, comprising:
a DRM vector generation unit for generating a plurality of DRM vectors according to a tacit information between a DRM enciphering apparatus and the DRM deciphering apparatus; and
a content object generation unit for deciphering the DRM objects respectively according to the plurality of DRM vectors to generate a plurality of content objects.

26. The DRM deciphering apparatus according to claim 25, wherein the content object generation unit comprises:
a key deciphering unit for deciphering the plurality of DRM objects according to a key information to generate a plurality of vector enciphering object; and
a vector deciphering unit for deciphering the plurality of vector enciphering objects according to the plurality of DRM vectors to generate the plurality of content objects.

27. The DRM deciphering apparatus according to claim 25, wherein the content object generation unit comprises:
an enciphering vector generation unit for generating a plurality of enciphering vectors according to a key information and the plurality of DRM vectors; and
a vector deciphering unit for deciphering the DRM objects according to the enciphering vectors to generate a plurality of content objects.

28. The DRM deciphering apparatus according to claim 25, wherein the tacit information comprises a plurality of tacit values from which the plurality of DRM vectors are obtained through a logical operation.

29. The DRM deciphering apparatus according to claim 28, wherein the logical operation is an exclusive-or (XOR) operation or a hash function operation.

30. The DRM deciphering apparatus according to claim 28, wherein the plurality of tacit values comprises the information associated with the plurality of content objects, the ID of the DRM deciphering apparatus, the transaction number of the digital content, the request time of the DRM deciphering apparatus, the previous last requested object ID of the DRM deciphering apparatus, the user information of the DRM deciphering apparatus, or any combination of above.

31. The DRM deciphering apparatus according to claim 25, wherein the plurality of DRM vectors have a fixed length.

32. The DRM deciphering apparatus according to claim 25, wherein the plurality of DRM vectors are different values from each other.
